(19) United States
(12) Patent Application Publication
(10) Pub. No.: US 2026/0228284 A1
(43) Pub. Date: Aug. 6, 2026

(54) GENERATING SPARSE INDICES FOR EVENT LOG INFORMATION

(71) Applicant: Anomali Incorporated, Redwood City, CA (US)

(72) Inventors: Wei Huang, Los Altos Hills, CA (US); Fang Chen, Redwood City, CA (US)

(21) Appl. No.: 19/461,519

(22) Filed: Jan. 27, 2026

Related U.S. Application Data
(60) Provisional application No. 63/754,212, filed on Feb. 5, 2025.

(51) Int. Cl. G06F 16/903; G06F 16/901

(52) U.S. Cl. CPC G06F 16/90344; G06F 16/901

(57) ABSTRACT

Systems and methods are disclosed herein for generating a sparse index for event logs. An application buffers a plurality of event logs during a time window, and populates a sparse index by, for each respective term of a plurality of indexable terms within buffered event logs, determining a respective count of event logs having the respective term during the time window, determining whether the respective count exceeds a threshold, responsive to determining that the respective count does not exceed the threshold, indexing the respective term, and responsive to determining that the respective count exceeds the threshold, refraining from indexing the respective term. The application receives a search query for a string of terms, and returns matching ones of the plurality of event logs as results of the search query using the sparse index.

### CROSS REFERENCE TO RELATED APPLICATIONS

This application claims the benefit of priority under 35 USC 119(e) to U.S. Provisional Patent Application No.: 63/754,212, filed on February 5, 2025, which is incorporated herein by reference it its entirety.

### TECHNICAL FIELD

This disclosure is generally directed to improved search functionality, and more specifically is directed to selectively indexing event logs to improve index utility while reducing memory overhead.

### BACKGROUND

Traditional index technology requires huge amounts of memory to index certain fields of event logs. Much of what is stored results in waste, because many indexed fields are not useful due to the field being noisy. As an example, traditional approaches store event logs for web traffic of a group of users. It is common for all of those users perform all of their web searches on a same popular web search website, and for web searches to take up a large percentage of overall web traffic. The traditional approaches would then index the web search website itself for each event log where that web search website is accessed. This takes up immense amount of memory in a bloated index, while not serving any useful purpose, as refining a search result on the basis of web search website will yield minimal or no further clarity on results because most of the event logs would survive the filter given that most users used that same web search website.

### SUMMARY

The systems and methods disclosed herein perform sparse indexing for event logs, intelligently indexing rare values while avoiding indexing based on common values. This approach enables users to leverage the index to find useful information more effectively, given that a much smaller subset of event logs will correspond to any given indexed value than a traditional approach would yield, thereby reducing latency and network bandwidth. This approach also saves tremendous memory space by avoiding indexing terms that would not be useful in a search, reducing memory usage for the index by an order of magnitude or more.

As an example, in the cybersecurity space, a threat hunter might use a sparse index to effectively identify the source of a threat to an entity. Users from the entity might access www.google.com to perform web searches frequently, say ten thousand times in a five minute interval. Therefore, if the threat hunter used www.google.com to identify event logs where a traditional indexing approach is used, ten thousand event logs would match, barely reducing the search space for the threat hunt. The systems and methods disclosed herein would avoid indexing www.google.com, and would instead index rarer terms, such as a malicious destination IP address that only ten hosts hit within that same five minute interval. This reduces the search space, improving the utility of the index to more quickly hunt a threat (or achieve any desired end), all while saving huge amounts of storage space relative to a traditional bloated index.

In some embodiments, a sparse index tool buffers a plurality of event logs during a time window, and populating a sparse index for the event logs. To populate the sparse index, for each respective term of a plurality of indexable terms within buffered event logs, the sparse index tool determines a respective count of event logs having the respective term during the time window, and determines whether the respective count exceeds a threshold. Responsive to determining that the respective count does not exceed the threshold, the sparse index tool indexes the respective term. Responsive to determining that the respective count exceeds the threshold, the sparse index tool refrains from indexing the respective term. The sparse index tool receives a search query for a string of terms, and returns matching ones of the plurality of event logs as results of the search query using the sparse index.

### BRIEF DESCRIPTION OF DRAWINGS

The disclosed embodiments have other advantages and features which will be more readily apparent from the detailed description, the appended claims, and the accompanying figures(or drawings). A brief introduction of the figures is below.

FIG. 1 illustrates one embodiment of a system environment for implementing a sparse index tool.

FIG. 2 illustrates one embodiment of exemplary modules and databases of the sparse index tool.

FIG. 3 is a block diagram illustrating components of an example machine able to read instructions from a machine-readable medium and execute them in a processor (or controller).

FIG. 4 is a flowchart showing an exemplary process for creating and using a sparse index, in accordance with an embodiment.

### DETAILED DESCRIPTION

The Figures(FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

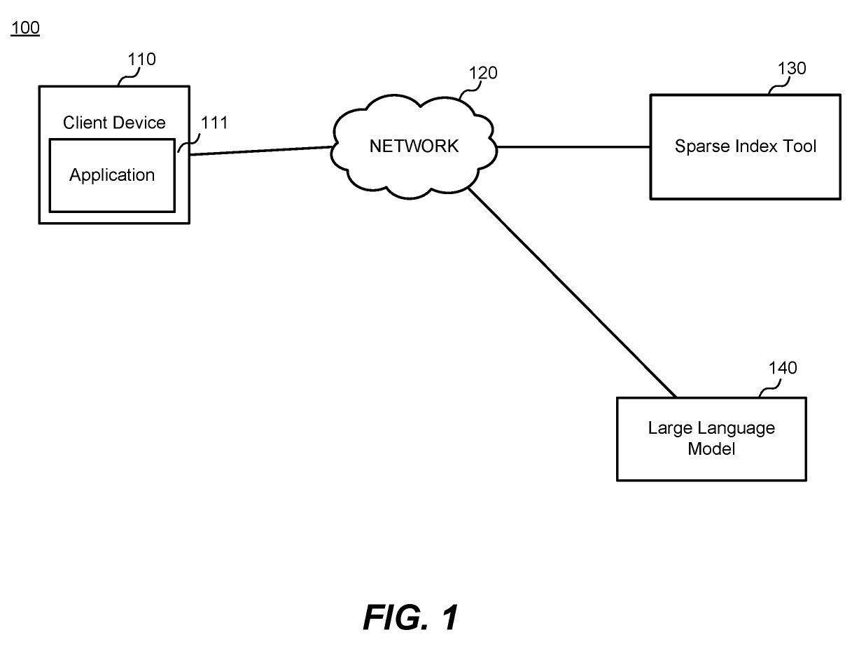

FIGURE(FIG.) 1 illustrates one embodiment of a system environment for implementing a search tool. As depicted in FIG. 1, environment 100 includes various devices, including client device 110, network 120, sparse index tool 130, and large language model service 140. A tool, as used herein, is a collection of one or more cloud resources that together, perhaps in coordination with other entities such as application 111, form a client-facing tool.

Client device 110 may, by way of application 111, interface with sparse index tool 130. Application 111 is an application installed on client device 110 and/or accessible by way of a browser of client device 110. Some or all functionality of sparse index tool 130 described herein may be distributed or fully performed by application 111 on a client device, or vice versa. Where reference is made herein to activity performed by application 111, it equally applies that sparse index tool 130 may perform that activity off of the client device, and vice versa.

Network 120 may be any network or combination of networks, such as the Internet, a wireless and/or wired network, a local area network, a wideband network, or any other data communications means that facilitates communications between devices, services, and sources disclosed herein.

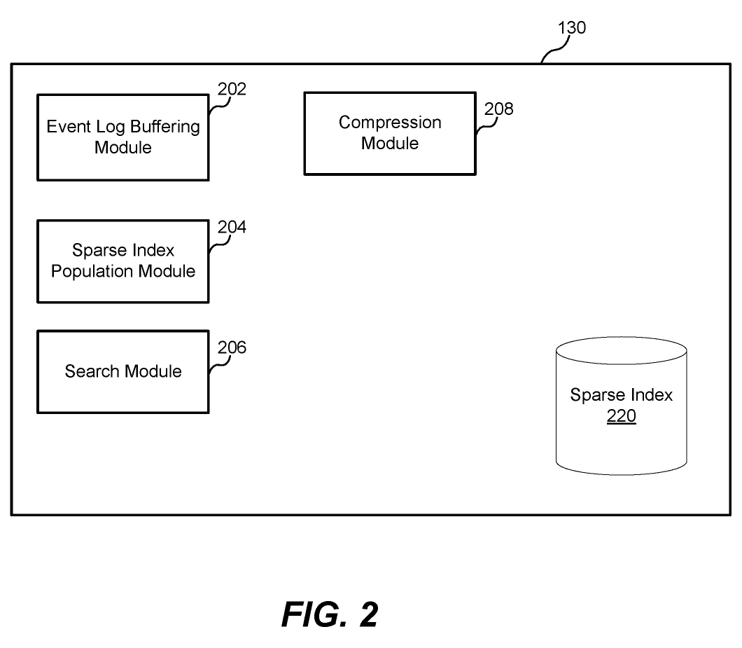

Sparse index tool 130 is used by client devices 110 to perform searches for queries input by users and to provide search results. Sparse index tool 130 intelligently indexes rare data, while not indexing common data, thereby improving the utility of the sparse index as an accurate search tool, while avoiding wastefully storing indices for common data. Further details about the operation of sparse index tool 130 are described below with reference to FIG. 2.

Large language model service 140 may be any service or combination of services that provide large language models (e.g., OpenAI, Llama3, etc.). In some embodiments, sparse index tool 130 may have its own internal large language model service 140 and need not use an external large language model service. Large language model is merely exemplary, and any generative artificial intelligence model may be used where large language models are mentioned (e.g., small language models).

FIG. 2 illustrates one embodiment of modules and databases of the sparse index tool. As depicted in FIG. 2, sparse index tool 130 includes event log buffering module 202, sparse index population module 204, search module 206, compression module 208, and sparse index 220. These modules and databases are merely illustrative; fewer or more modules and/or databases may be used to achieve the functionality disclosed herein.

Sparse index tool 130 may be part of a system that ingests event logs and enables downstream activity based on the event logs. The system may be, for example, a cybersecurity tool that monitors for cyber threats based on event logs. Another example of the system may be a search tool that enables a search to be performed for data within the event logs. An example of such a search tool is a threat hunting tool, where the event logs may be iteratively searched to identify threats within the event logs. The event logs may be events for a certain entity (e.g., events generated from users working at a same entity) or may cross multiple entities.

Event log buffering module 202 captures a set of event logs for analysis. The buffer may be populated until one or more criteria are reached, and when the criteria are reached, analysis is performed. For example, the criteria may be that a time window has elapsed (e.g., 5 minutes), a certain amount of event logs have been collected (e.g., one million event logs), or any other criteria. The criteria may be sliding. For example, where the criteria is a time window, the time window may slide, where for each slide, analysis is performed when the criteria is reached. There may be overlap in event logs being analyzed, or a new buffer window may open without overlap for next event logs to be analyzed as a prior buffer window closes (or with overlap when a parameter is reached, such as a percentage of the total criteria like 80% of the time window, 70% of the amount of event logs, etc.).

Event log buffering may occur in parallel for many different event types. For example, event log buffering module 202 may separately use a first buffer for activity occurring with a first group of users, and may use a different second buffer for activity occurring with a second group of users. Any logical delineation between event types may be used (e.g., different divisions within an entity having many users, such as hierarchical or subsidiary divisions). Different event log buffers may result in different indices, each of which may separately be used to perform a relevant search.

Sparse index population module 204 populates sparse index 220 based on analysis of each completed buffer. Each event log contains terms, several of which are indexable. The term indexable, as used herein, may refer to categories of terms within an event logs that are designated to be indexed. These terms may be defined by an administrator, indicated by a large language model (e.g., having been prompted to identify useful term categories for indexing), or may be defined in any other manner. While any or all terms may be indexable, typically, not all terms would be indexed, as there is a memory cost to indexing terms, and some terms are not useful to index.

In order to define terms as indexable, rules for what is indexable may be created. In some embodiments, an administrator explicitly inputs rules, where terms matching the rules are to be indexed and terms not matching the rules are not to be indexed. The rules may explicitly name a category (e.g., do not index web search domains), or may describe other factors (e.g., do not index a term that appears more than a threshold number of times in any given time window). In some embodiments, the administrator prompts a large language model to generate rules for indexing. The large language model and/or the rules may modify what terms qualify based on changing conditions (e.g., a term that was rare and later on appears over a threshold amount of times in a given window of time may transition from being indexed to not being indexed).

In some embodiments, sparse index population module 204 performs analysis by determining, for each term category, a count of event logs within the buffer having a same term. For example, within a time window, 10k users may perform a search using www.google.com, and 500 users may perform a search using www.chatgpt.com. Thus, sparse index population module 204 may output a count of 10k for www.google.com, and a count of 500 for www.chatgpt.com. Each count may be compared to a threshold count. The threshold count may differ based on term category (e.g., a higher or lower count may be used for destination name, as compared to source).

Where count exceeds the count threshold for a given term, sparse index population module 204 refrains from indexing the term. Where count does not exceed the count threshold, sparse index population module 204 indexes the term (e.g., stores a pointer from the term to each corresponding event log). Optionally, where a term is not to be indexed, rather than index the term for all event logs, a count for the time window may be indexed, which is much smaller to store than pointers, thereby saving significant memory space. The count may serve a function of explainability, where a user seeking to filter using a term is provided the count, optionally with an explanation of the count being over a threshold that thereby renders the associated term not useful as a filter. What results is a sparse index, where rare terms that would differentiate a search and be useful are indexed for all event logs, while common terms that would not be useful to differentiate event logs within a search are not indexed. This saves an order of magnitude or more of storage space, while achieving a more useful index.

In some embodiments, sparse index population module 204 may expand the plurality of indexable terms using excess capacity afforded using the sparse index. For example, responsive to determining that less than a threshold amount of index memory is used (e.g., across a time duration or a certain number of buffer lengths), sparse index population module 204 may determine that it is possible to expand the indexable terms to include one or more additional term categories as indexable while still staying within memory requirements. In such a scenario, sparse index population module 204 may prompt an administrator to add one or more term categories. Alternatively or additionally, sparse index population module 204 may prompt large language model service 140 to output one or more term categories that would be useful (e.g., likely to differentiate search). Similarly, where the memory threshold is exceeded, sparse index population module 204 may take similar steps (e.g., using an LLM or an administrator) to remove one or more indexable terms.

Enabling index expansion may render the index more useful for performing a search. For example, a typical vehicle database may index vehicles by make, model, and year. Vehicles entering a parking facility may be indexed, and under the principles discussed above, sparse index population module 204 may refrain from indexing the term “Toyota” where Toyota vehicles are entering the facility at higher than a threshold frequency. Where this saves sufficient room in the index, additional features may be added, such as zero-to-sixty time, steering wheel type (e.g., yolk steering wheels may be added without significantly increasing the size of the index, where most cars have a round steering wheel that would not be indexed due to their frequency).

Search module 206 receives a search query for a string of terms. This may be a traditional search, or a natural language search (e.g., facilitated using large language model service 140). Search module 206 returns matching ones of the plurality of event logs as results of the search query using the sparse index. Search module 206 may further return, within the results of the search, counts for terms within the string of terms having counts that exceed the threshold (e.g., where sparse index 220 is populated with counts, rather than pointers to noisy data). Event logs may be compressed for storage, where the compressed storage is what is searched. To index, pointers may be added for each entry of the sparse index to its corresponding portion of each associated one of the compressed event logs.

Compression module 208 may compress the sparse index and the underlying data to which the index points. Compression module 208 may compress the sparse index using any known compression algorithm, typically achieving a 10 to 1 compression ratio. A synergistic effect is achieved by using a sparse index, which typically reduces an index size substantially (e.g., by 90%), and having that sparse index point to compressed data that also reduces the data size by 90%, thereby reducing the data needed to produce an index and have the index point to stored data by at least an order of magnitude.

### Computing Machine Architecture

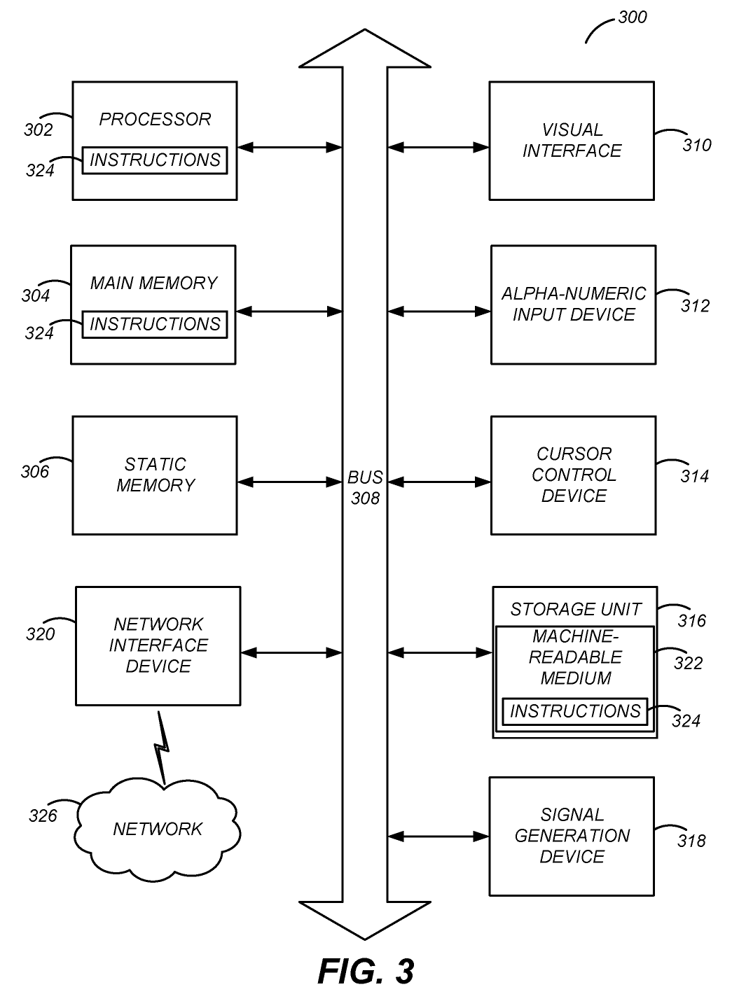

FIG. 3 is a block diagram illustrating components of an example machine able to read instructions from a machine-readable medium and execute them in a processor (or controller). Specifically, FIG. 3 shows a diagrammatic representation of a machine in the example form of a computer system 300 within which program code (e.g., software) for causing the machine to perform any one or more of the methodologies discussed herein may be executed. The program code may be comprised of instructions 324 executable by one or more processors 302. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 324 (sequential or otherwise) that specify actions to be taken by that machine. Further, while only a single machine is illustrated, the term “machine” shall also be taken to include any collection of machines that individually or jointly execute instructions 324 to perform any one or more of the methodologies discussed herein.

The example computer system 300 includes a processor 302 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 304, and a static memory 306, which are configured to communicate with each other via a bus 308. The computer system 300 may further include visual display interface 310. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 310 may include or may interface with a touch enabled screen. The computer system 300 may also include alphanumeric input device 312 (e.g., a keyboard or touch screen keyboard), a cursor control device 314 (e.g., a mouse, a trackball, a joystick, a motion sensor, or other pointing instrument), a storage unit 316, a signal generation device 318 (e.g., a speaker), and a network interface device 320, which also are configured to communicate via the bus 308.

The storage unit 316 includes a machine-readable medium 322 on which is stored instructions 324 (e.g., software) embodying any one or more of the methodologies or functions described herein. The instructions 324 (e.g., software) may also reside, completely or at least partially, within the main memory 304 or within the processor 302 (e.g., within a processor’s cache memory) during execution thereof by the computer system 300, the main memory 304 and the processor 302 also constituting machine-readable media. The instructions 324 (e.g., software) may be transmitted or received over a network 326 via the network interface device 320.

While machine-readable medium 322 is shown in an example embodiment to be a single medium, the term “machine-readable medium” should be taken to include a single medium or multiple media (e.g., a centralized or distributed database, or associated caches and servers) able to store instructions (e.g., instructions 324). The term “machine-readable medium” shall also be taken to include any medium that is capable of storing instructions (e.g., instructions 324) for execution by the machine and that cause the machine to perform any one or more of the methodologies disclosed herein. The term “machine-readable medium” includes, but not be limited to, data repositories in the form of solid-state memories, optical media, and magnetic media.

### Exemplary Process

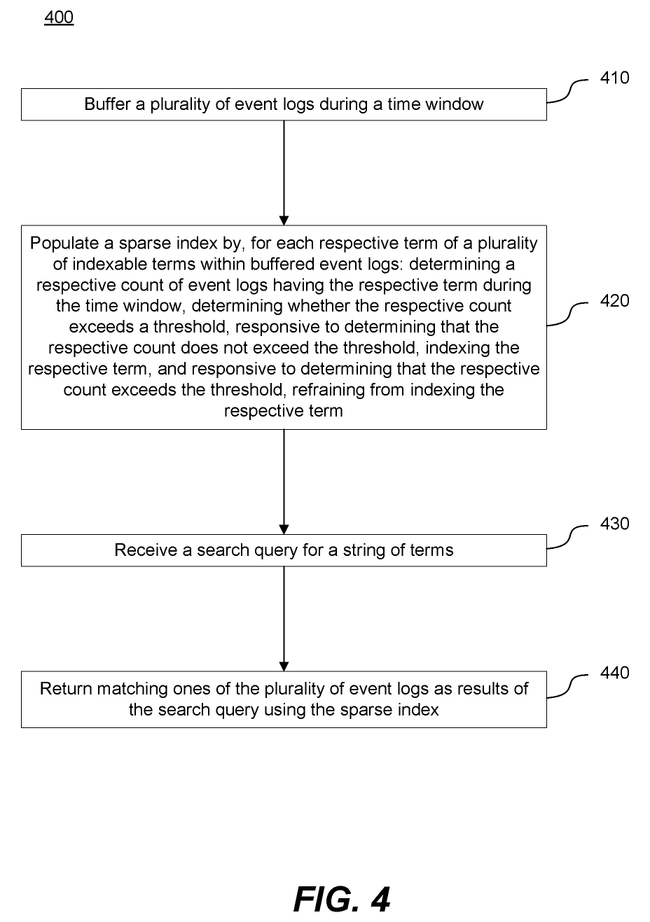

FIG. 4 is a flowchart showing an exemplary process for creating and using a sparse index, in accordance with an embodiment. As depicted in FIG. 4, process 400 may be run based on one or more processors executing instructions stored in a non-transitory computer-readable medium. Process 400 may begin with sparse index tool 130 buffering 410 a plurality of event logs during a time window (e.g., using event log buffering module 202). Sparse index tool 130 may populate 420 a sparse index (e.g., using sparse index population module 204) by, for each respective term of a plurality of indexable terms within buffered event logs: determining a respective count of event logs having the respective term during the time window, determining whether the respective count exceeds a threshold, responsive to determining that the respective count does not exceed the threshold, indexing the respective term, and responsive to determining that the respective count exceeds the threshold, refraining from indexing the respective term.

Sparse index tool 130 may receive 430 a search query for a string of terms, and may return 440 matching ones of the plurality of event logs as results of the search query using the sparse index (e.g., using search module 206).

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for implementing a sparse index tool through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
buffering a plurality of event logs during a time window;
populating a sparse index by, for each respective term of a plurality of indexable terms within buffered event logs:
determining a respective count of event logs having the respective term during the time window,
determining whether the respective count exceeds a threshold,
responsive to determining that the respective count does not exceed the threshold, indexing the respective term, and
responsive to determining that the respective count exceeds the threshold, refraining from indexing the respective term;
receiving a search query for a string of terms; and
returning matching ones of the plurality of event logs as results of the search query using the sparse index.

2. The method of claim 1, wherein the time window is a sliding time window, and wherein, as the sliding time window slides, the sparse index continues to be populated depending on respective counts of respective terms within the sliding time window.

3. The method of claim 1, wherein the plurality of indexable terms comprises terms within categories designated for indexing, and wherein terms other than the plurality of indexable terms are not indexed.

4. The method of claim 1, further comprising, further responsive to determining that the respective count exceeds the threshold, indexing the respective count in associated with the respective term.

5. The method of claim 4, further comprising returning, within the results of the search query, counts for terms within the string of terms having counts that exceed the threshold.

6. The method of claim 1, further comprising compressing the plurality of event logs into compressed event logs for storage, and adding pointers for each entry of the sparse index to its corresponding portion of each associated one of the compressed event logs.

7. The method of claim 1, further comprising expanding the plurality of indexable terms using excess capacity afforded using the sparse index.

8. A non-transitory computer-readable medium comprising memory with instructions encoded thereon that, when executed by one or more processors, cause the one or more processors to perform operations, the instructions comprising instructions to:
buffer a plurality of event logs during a time window;
populate a sparse index by, for each respective term of a plurality of indexable terms within buffered event logs:
determining a respective count of event logs having the respective term during the time window,
determining whether the respective count exceeds a threshold,
responsive to determining that the respective count does not exceed the threshold, indexing the respective term, and
responsive to determining that the respective count exceeds the threshold, refraining from indexing the respective term;
receive a search query for a string of terms; and
return matching ones of the plurality of event logs as results of the search query using the sparse index.

9. The non-transitory computer-readable medium of claim 8, wherein the time window is a sliding time window, and wherein, as the sliding time window slides, the sparse index continues to be populated depending on respective counts of respective terms within the sliding time window.

10. The non-transitory computer-readable medium of claim 8, wherein the plurality of indexable terms comprises terms within categories designated for indexing, and wherein terms other than the plurality of indexable terms are not indexed.

11. The non-transitory computer-readable medium of claim 8, the instructions further comprising instructions to, further responsive to determining that the respective count exceeds the threshold, index the respective count in associated with the respective term.

12. The non-transitory computer-readable medium of claim 11, the instructions further comprising instructions to return, within the results of the search query, counts for terms within the string of terms having counts that exceed the threshold.

13. The non-transitory computer-readable medium of claim 8, the instructions further comprising instructions to compress the plurality of event logs into compressed event logs for storage, and instructions to add pointers for each entry of the sparse index to its corresponding portion of each associated one of the compressed event logs.

14. The non-transitory computer-readable medium of claim 8, the instructions further comprising instructions to expand the plurality of indexable terms using excess capacity afforded using the sparse index.

15. A system comprising:
memory with instructions encoded thereon; and
one or more processors that, when executing the instructions, are caused to perform operations comprising:
buffering a plurality of event logs during a time window;
populating a sparse index by, for each respective term of a plurality of indexable terms within buffered event logs:
determining a respective count of event logs having the respective term during the time window,
determining whether the respective count exceeds a threshold,
responsive to determining that the respective count does not exceed the threshold, indexing the respective term, and
responsive to determining that the respective count exceeds the threshold, refraining from indexing the respective term;
receiving a search query for a string of terms; and
returning matching ones of the plurality of event logs as results of the search query using the sparse index.

16. The system of claim 15, wherein the time window is a sliding time window, and wherein, as the sliding time window slides, the sparse index continues to be populated depending on respective counts of respective terms within the sliding time window.

17. The system of claim 15, wherein the plurality of indexable terms comprises terms within categories designated for indexing, and wherein terms other than the plurality of indexable terms are not indexed.

18. The system of claim 15, the operations further comprising, further responsive to determining that the respective count exceeds the threshold, indexing the respective count in associated with the respective term.

19. The system of claim 18, the operations further comprising returning, within the results of the search query, counts for terms within the string of terms having counts that exceed the threshold.

20. The system of claim 15, the operations further comprising compressing the plurality of event logs into compressed event logs for storage, and adding pointers for each entry of the sparse index to its corresponding portion of each associated one of the compressed event logs.
